(19) United States
(12) Patent Application Publication
(10) Pub. No.: US 2014/0044313 A1
(43) Pub. Date: Feb. 13, 2014

(54) REPORTING SYSTEM AND REPORTING METHOD FOR STOLEN VEHICLES

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(21) Appl. No.: 13/663,634

(22) Filed: Oct. 30, 2012

(30) Foreign Application Priority Data
Aug. 8, 2012 (TW) 101128532

(51) Int. Cl. G06K 9/00

(52) U.S. Cl. 382/105

(57) ABSTRACT

A reporting method includes: capturing an image of a vehicle through a camera. Detecting the image to obtain a number of a license plate. Encrypting the number of the license plate and a position of the camera. Deciphering the encrypted data to obtain the position and the number of the license plate. Comparing the deciphered number of the license plate with numbers of license plates of stolen vehicles to determine whether the deciphered number of the license plate is the same as one of the numbers of the license plates. Storing the position of the camera and the deciphered number of the license plate in response to the deciphered number of the license plate being the same as one of the numbers of the license plates, and transmitting the position of the camera and the deciphered number of the license plate to offices.

### BACKGROUND

1. Technical Field

The present disclosure relates to a system and a method for reporting stolen vehicles.

2. Description of Related Art

When an officer wants to check the registration status of a vehicle, the officer needs to input a number of a license plate of the vehicle manually on a special device. This is inconvenient.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an embodiment of a reporting system, wherein the reporting system includes a first storage unit and a second storage unit.

FIG. 2 is a block diagram of the first storage unit of FIG. 1.

FIG. 3 is a block diagram of the second storage unit of FIG. 1.

FIGS. 4-6 are schematic views showing how the reporting system operates.

FIGS. 7A and 7B are flowcharts of an embodiment of a reporting method.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

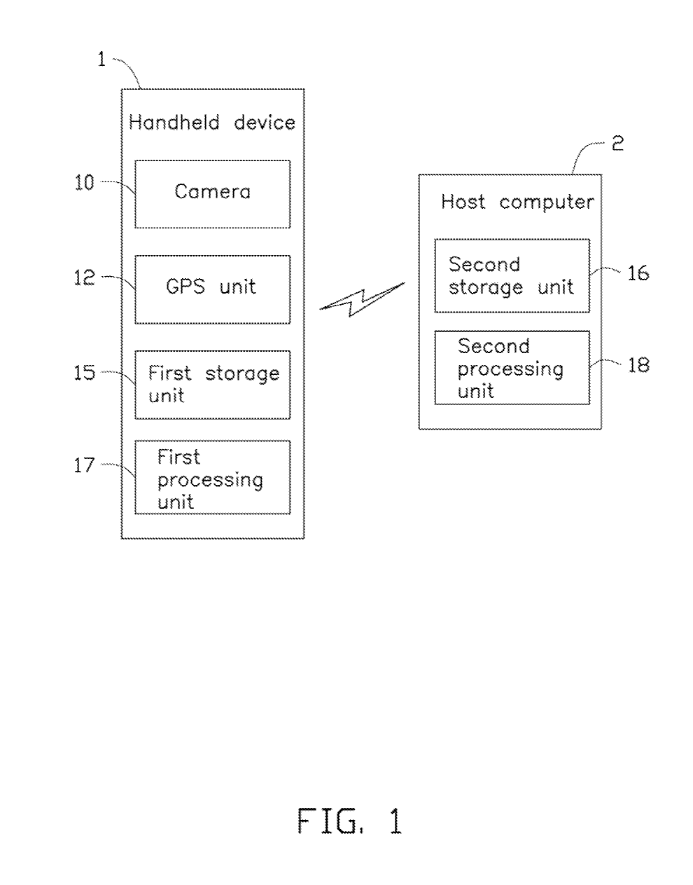

FIG. 1 shows an embodiment of a reporting system. The reporting system includes a camera 10, a global position system (GPS) unit 12, a first storage unit 15, a second storage unit 16, a first processing unit 17, and a second processing unit 18. In the embodiment, the camera 10, the GPS unit 12, and the first storage unit 15 are all set in a handheld device 1, such as a mobile phone. The second processing unit 18 and the second storage unit 16 are both set in a host computer 2 which may be located in an office.

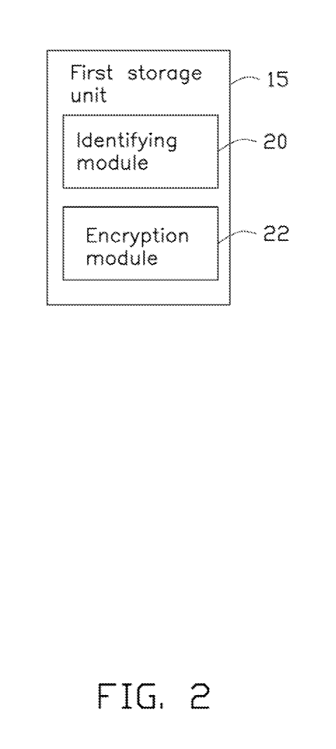

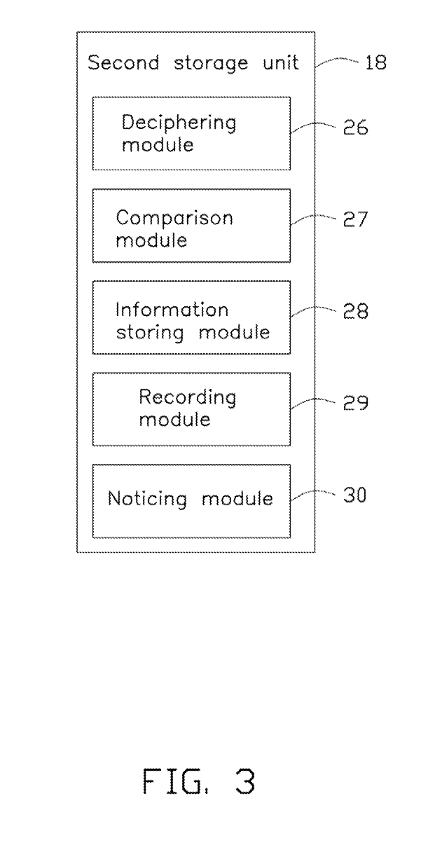

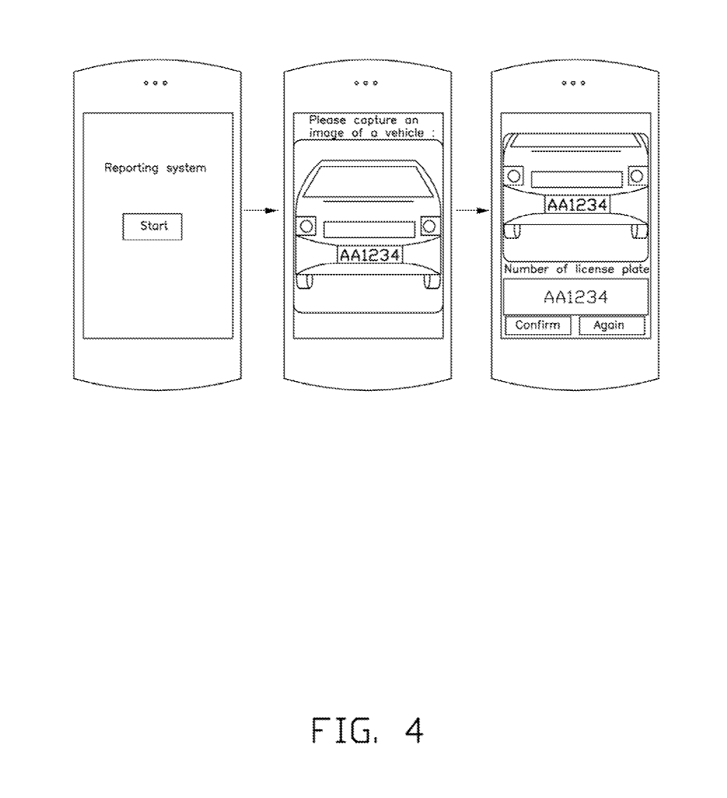

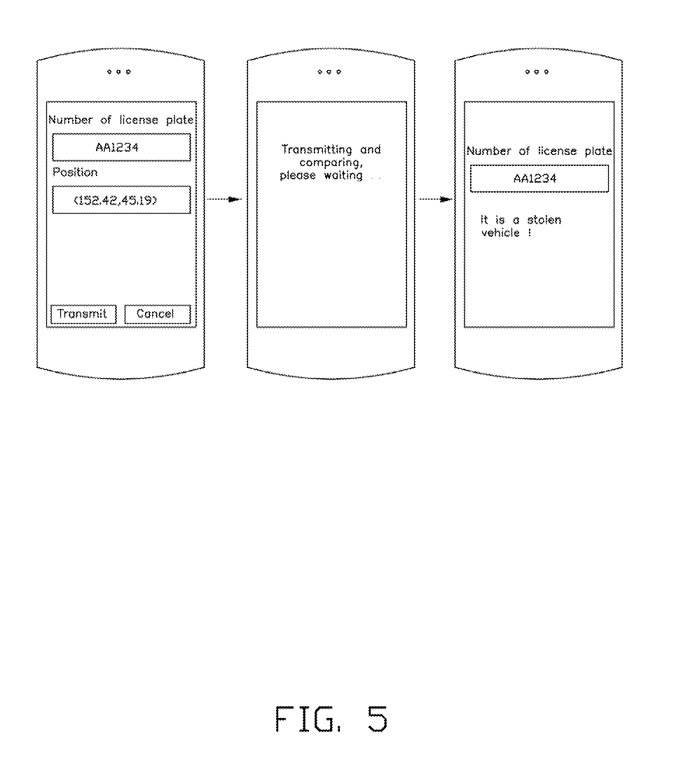

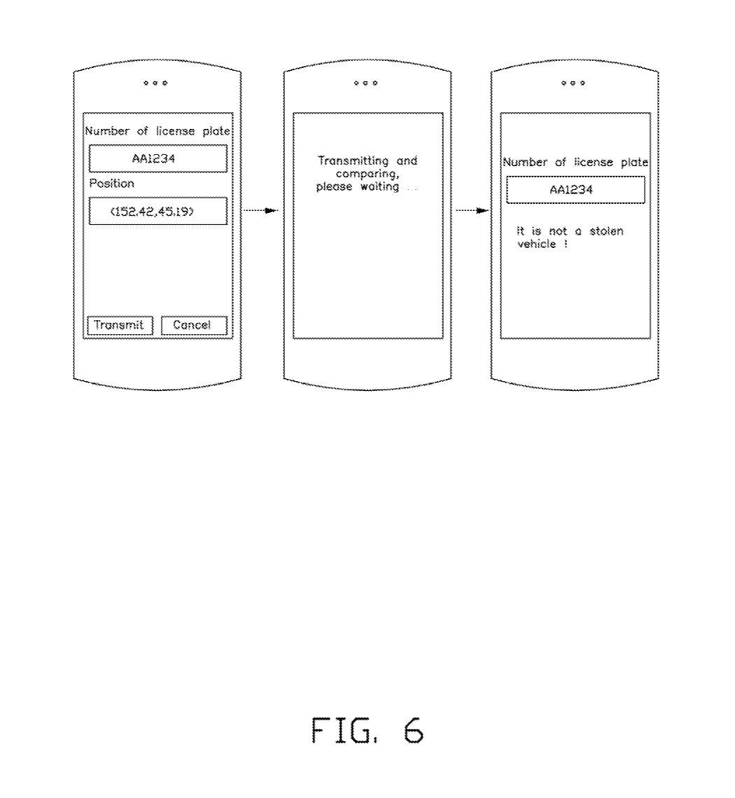

FIGS. 2-6 show the first storage unit 15 of the embodiment. The first storage unit 15 includes an identifying module 20 and an encryption module 22, which may include one or more computerized instructions executed by the first processing unit 17. The second storage unit 16 includes a deciphering module 26, a comparison module 27, an information storing module 28, a recording module 29, and a noticing module 30, which may include one or more computerized instructions executed by the second processing unit 18.

The camera 10 captures an image of a vehicle. The GPS unit 12 obtains a position of the handheld device 1.

The identifying module 20 analyzes the image captured by the camera 10 to obtain a number of a license plate of the vehicle. The encryption module 22 encrypts the number of the license plate of the vehicle, the position of the handheld device 1, and information of a user of the handheld device 1, and transmits the encrypted data to the host computer 2 wirelessly.

The deciphering module 26 deciphers the encrypted data to obtain the position of the handheld device 1, the information of the user of the handheld device 1, and the number of the license plate of the vehicle, and transmits the number of the license plate of the vehicle to the comparison module 27. The comparison module 27 compares the deciphered number of the license plate with a plurality of numbers of license plates which belong to stolen vehicles stored in the information storing module 28, to determine whether the deciphered number of the license plate is the same as one of the numbers of the license plates stored in the information storing module 28.

If the deciphered number of the license plate is the same as one of the numbers of the license plates stored in the information storing module 28, the recording module 29 stores the position of the handheld device 1, the information of the user of the handheld device 1, and the deciphered number of the license plate. The noticing module 30 transmits the comparison result to the handheld device 1 to inform the user that the vehicle is a stolen vehicle. In addition, the noticing module 30 determines an office nearest to the position of the handheld device 1, and transmits the position of the handheld device 1, the information of the user of the handheld device 1, and the deciphered number of the license plate to the office, such that the office can dispatch an officer to deal with the stolen vehicle.

If the deciphered number of the license plate is different from each of the numbers of the license plates stored in the information storing module 28, the noticing module 30 transmits the comparison result to the handheld device 1 to inform the user that the vehicle is not a stolen vehicle.

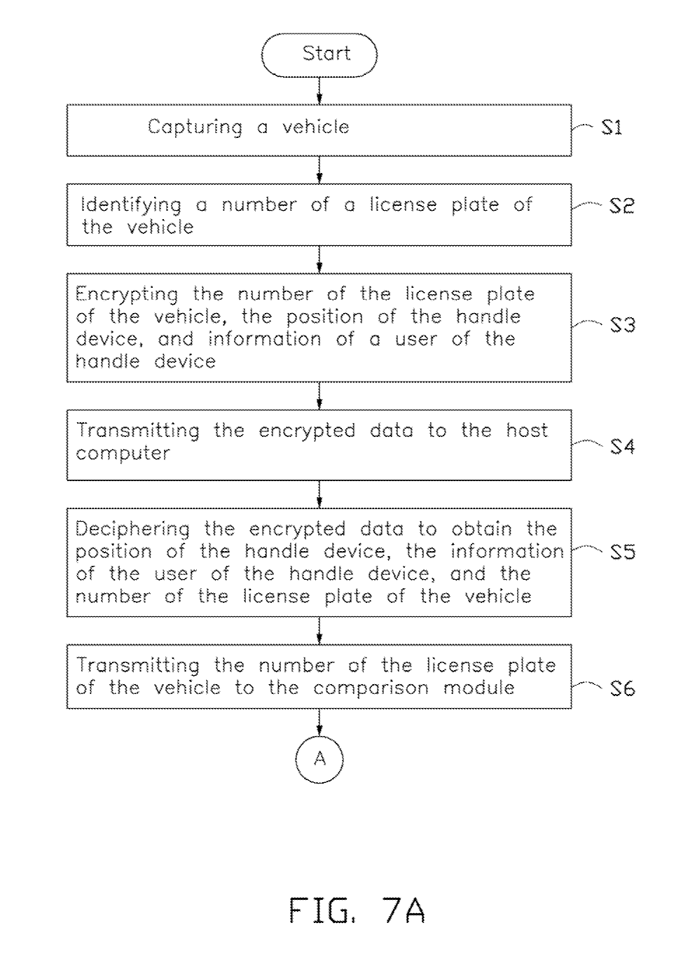

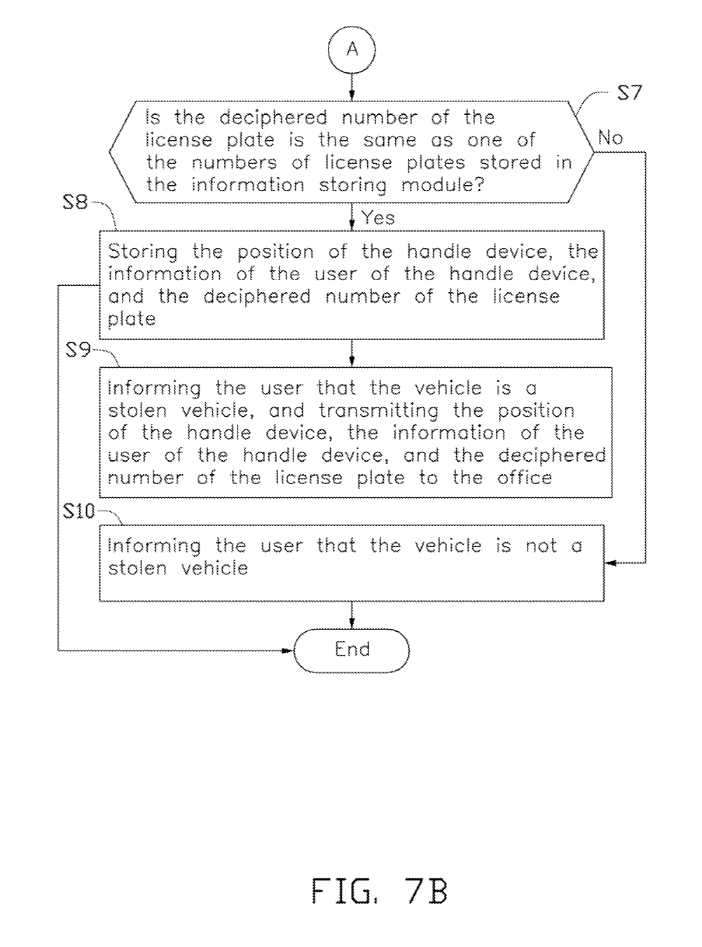

FIGS. 7A and 7B show a reporting method, the reporting method includes the following steps.

In step S1, the camera 10 captures an image of a vehicle.

In step S2, the identifying module 20 analyzes the image captured by the camera 10 to obtain a number of a license plate of the vehicle.

In step S3, the encryption module 22 encrypts the number of the license plate of the vehicle, the position of the handheld device 1, and information of a user of the handheld device 1.

In Step S4, the encrypted data is transmitted to the host computer 2.

In step S5, the deciphering module 26 deciphers the encrypted data to obtain the position of the handheld device 1, the information of the user of the handheld device 1, and the number of the license plate of the vehicle.

In step S6, the number of the license plate of the vehicle is transmitted to the comparison module 27.

In step S7, the comparison module 27 compares the deciphered number of the license plate with a plurality of numbers of license plates which belong to stolen vehicles stored in the information storing module 28 to determine whether the deciphered number of the license plate is the same as one of the numbers of the license plates stored in the information storing module 28. If the deciphered number of the license plate is the same as one of the numbers of the license plates stored in the information storing module 28, the process flows to step S8. If the deciphered number of the license plate is different from each of the numbers of the license plates stored in the information storing module 28, the process flows to step S10.

In step S8, the recording module 29 stores the position of the handheld device 1, the information of the user of the handheld device 1, and the deciphered number of the license plate.

In step S9, the noticing module 30 transmits the comparison result to the handheld device 1 to inform the user that the vehicle is a stolen vehicle. In addition, the noticing module 30 determines an office nearest to the position of the handheld device 1, and transmits the position of the handheld device 1, the information of the user of the handheld device 1, and the deciphered number of the license plate to the office, such that the office can dispatch an officer to deal with the stolen vehicle.

In step S10, the noticing module 30 transmits the comparison result to the handheld device 1 to inform the user that the vehicle is not a stolen vehicle.

The foregoing description of the embodiments of the disclosure has been presented only for the purposes of illustration and description and is not intended to be exhaustive or to limit the disclosure to the precise forms disclosed. Many modifications and variations are possible in light of the above disclosure. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A reporting system, comprising:
a camera to capture an image of a vehicle;
a global position system (GPS) unit mounted to a handheld device to obtain a position of the handheld device;
a first processing unit;
a first storage unit connected to the first processing unit, the camera, and the GPS unit, and storing a plurality of programs to be executed by the first processing unit, wherein the first storage unit stores:
an identifying module to detect the image captured by the camera to obtain a number of a license plate of the vehicle; and
an encryption module to encrypt the number of the license plate of the vehicle and the position of the handheld device;
a second processing unit; and
a second storage unit connected to the second processing unit, and storing a plurality of programs to be executed by the second processing unit, wherein the second storage unit stores:
an deciphering module to decipher the encrypted data to obtain the position of the handheld device and the number of the license plate of the vehicle;
an information storing module to store a plurality of numbers of license plates which belong to stolen vehicles;
a comparison module to compare the deciphered number of the license plate with the numbers of the license plates stored in the information storing module to determine whether the deciphered number of the license plate is the same as one of the numbers of the license plates;
a recording module to store the position of the handheld device and the deciphered number of the license plate in response to the deciphered number of the license plate being the same as one of the numbers of the license plates; and
a noticing module to transmit the deciphered number of the license plate and the position of the handheld device to offices in response to the deciphered number of the license plate being the same as one of the numbers of the license plates.

2. The reporting system of claim 1, wherein the camera, the GPS unit, and the first storage unit are mounted in the handheld device; the second storage unit is mounted in a host computer.

3. The reporting system of claim 2, wherein the encryption module further encrypts information of a user of the handheld device, the deciphering module further decipher the encrypted data to obtain the information of the user of the handheld device, the noticing module further transmits the deciphered information of the user of the handheld device to the offices in response to the deciphered number of the license plate being the same as one of the numbers of license plates.

4. The reporting system of claim 1, wherein the noticing module further informs a user of the handheld device that the vehicle is a stolen vehicle, in response to the deciphered number of the license plate being the same as one of the numbers of the license plates.

5. The reporting system of claim 1, wherein the noticing module further informs a user of the handheld device that the vehicle is not a stolen vehicle, in response to the deciphered number of the license plate being different from each of the numbers of the license plates stored in the information storing module.

6. A reporting method, comprising:
capturing an image of a vehicle through a camera;
analyzing the image captured by the camera to obtain a number of a license plate of the vehicle;
encrypting the number of the license plate of the vehicle and a position of the camera obtained through a global position system (GPS) unit;
deciphering the encrypted data to obtain the position of the camera and the number of the license plate of the vehicle;
comparing the deciphered number of the license plate with a plurality of numbers of license plates which belong to stolen vehicles stored in an information storing module to determine whether the deciphered number of the license plate is the same as one of the numbers of the license plates stored in the information storing module;
storing the position of the camera and the deciphered number of the license plate in response to the deciphered number of the license plate being the same as one of the numbers of the license plates stored in the information storing module; and
transmitting the position of the camera and the deciphered number of the license plate to offices.

7. The reporting method of claim 6, wherein the GPS unit and the camera are mounted in a handheld device, information of an user of the handheld device is further encrypted, the encrypted information is further to be deciphered to obtain the information of the user of the handheld device, the information of the user of the handheld device is further transmitted to the offices.

8. The reporting method of claim 6, further comprising:
informing a user of the handheld device that the vehicle is a stolen vehicle, in response to the deciphered number of the license plate being the same as one of the numbers of the license plates.

9. The reporting method of claim 6, further comprising:
informing a user of the handheld device that the vehicle is not a stolen vehicle, in response to the deciphered number of the license plate being different from each of the numbers of the license plates stored in the information storing module.
